(19) United States
(12) Patent Application Publication
(10) Pub. No.: US 2011/0288958 A1
(43) Pub. Date: Nov. 24, 2011

(54) Systems, Methods and Computer Program Products for Rapid and Secure Delivery of a Purchased Item

(75) Inventors: Olu Obasanjo, New York, NY (US); Vincent Grosso, New York, NY (US)

(73) Assignee: METROSHOPR, New York, NY (US)

(21) Appl. No.: 13/105,979

(22) Filed: May 12, 2011

Related U.S. Application Data
(60) Provisional application No. 61/346,929, filed on May 21, 2010.

(51) Int. Cl. G06Q 30/00

(52) U.S. Cl. 705/26.81

(57) ABSTRACT

Systems, methods and computer program products are provided for implementing rapid and secure delivery of goods that have been purchased through e-commerce channels. Through these technologies customers can order goods while they are mobile and arrange for rapid delivery wherever they will be at the time of delivery, regardless of whether that location is at a permanent address. Thus, there can be a rapid identification of goods in a warehouse or store and the proper tracking and security for delivery on demand.

### CROSS-REFERENCE TO RELATED APPLICATION

This application claims the benefit of the filing date of U.S. Provisional Application Ser. No. 61/346,929, filed May 21, 2010, the entire disclosure of which is incorporated by reference as if set forth fully herein.

### FIELD OF THE INVENTION

The present invention pertains to the field of security in the delivery of items.

### BACKGROUND OF THE INVENTION

Customers around the world have embraced e-commerce and turned, in large numbers, to shopping over the Internet. Through websites that are operated directly by vendors or by third-parties, customers can now purchase an endless assortment of goods online and have these goods shipped directly to the customer's home.

Unfortunately, most e-commerce shopping experiences have one or more drawbacks. First, a customer usually must wait a day or more for the purchased item to be delivered, making efficient time sensitive solutions, such as those for catastrophic needs almost impossible. Second, a customer usually must have the item delivered to a permanent address, e.g., a home, business or school. Third, in known e-commerce channels there are not adequate safeguards to ensure that the correct goods are delivered to the correct destination.

The present invention seeks to make the e-commerce shopping experience more satisfying by addressing one or more of these shortcomings of present technologies and systems.

### SUMMARY OF THE INVENTION

The present invention is directed to the use of technology to provide for rapid and secure delivery to any location of an item that has been purchased.

According to a first embodiment, the present invention provides a system for secure and rapid delivery of an item. The system comprises: (a) a database comprising data that identifies an item that is available for sale and the location of the item; (b) an e-commerce website, wherein the e-commerce website is accessible to a customer and the customer may navigate the website in order to gain access to information in the database; (c) an inventory locator algorithm, wherein the inventory locator algorithm, after receiving a first piece of data comprising the customer's identity, a second piece of data comprising a delivery destination, and a third piece of data comprising an ordered item that has been selected by the customer, searches the database for a location of the ordered item that has the shortest estimated delivery time to the delivery destination; (d) an order identification code comprising information that corresponds to the first piece of data, the second piece of data and the third piece of data, wherein the order identification code is sent to the location of the ordered item that has the shortest estimated delivery time to the delivery destination; and (e) a verification algorithm, wherein the verification algorithm causes the system to transmit a customer identification code to the customer, and causes the system to issue a confirmation of correct delivery of the ordered item, if the system receives both the order identification code and the customer identification code from an agent.

According to a second embodiment, the present invention provides a method for ensuring rapid and secure delivery of one or more items. The method comprises: (a) receiving an order for an item from a customer, wherein the order contains the customer's identity, a delivery destination for the item, and an identification of the item; (b) searching a database for the location of the item that permits its delivery to the delivery destination in the shortest estimated time; (c) retrieving the item from a vendor, after receiving the order; (d) associating an order identification code (which may also be referred to as a tracking code) with the item; (e) sending a confirmation code to a customer; and (f) delivering the item to the customer at the delivery destination and verifying that the customer has received the confirmation code. Verification may for example be accomplished through the use one or more mobile devices.

According to a third embodiment, the present invention provides a computer program product stored in a tangible medium that comprises: (a) an e-commerce module, wherein through the e-commerce module a customer may access information about an item that may be purchased and delivered to the customer within a set timeframe and the customer may both purchase an item and designate a delivery destination; (b) an order fulfillment module, wherein the order fulfillment module is operably coupled to the e-commerce module and the order fulfillment module executes a set of instructions that determines the location of the item that determines the shortest estimated time of delivery to the delivery destination; (c) a tracking module, wherein the tracking module transmits an order identification code to be associated with the item; and (d) an authentication module, wherein the authentication module sends an identity confirmation code to the customer, and if the authentication module receives the identity confirmation code and the order identification code from an agent, then the authentication module transmits a confirmation of correct delivery. By way of a non-limiting example, one or more of the codes may be in the form of bar codes. For example, the identity confirmation code may be a bar code that is capable of being scanned and resent by the agent through a mobile communication device back to the authentication module.

The systems, methods and computer program products of the present invention may be used to identify an item in a warehouse or store, to enable proper tagging of the item after an order is placed and to coordinate timely delivery on demand. Thus, ordered items may be selected through e-commerce channels, requested on-demand and taken out of inventory and identified for precise delivery within a targeted timeframe.

### BRIEF DESCRIPTION OF THE FIGURE

FIG. 1 is a representation of an overview of a system of the present invention.

### DETAILED DESCRIPTION OF THE INVENTION

Through the use of the systems, methods and computer program products of the present invention, one may provide rapid and secure delivery of items. After defining a delivery destination and a timeframe within which delivery of a purchased item must be made, the systems, methods and computer program products permit a customer to purchase items that can be delivered within that timeframe and then determine from which vendors the item can be purchased so that there may be the fastest delivery within that timeframe, purchase that item from the vendor on behalf of the customer and deliver it to the delivery destination designated by the customer. Thus, a customer may browse a website in a manner similar to traditional e-commerce shopping experiences, but because of the invention described herein, obtain delivery quicker, to more destinations, and more securely and in a manner that solves time-sensitive, urgent or catastrophic needs than in the traditional shopping experiences with which the customer may be more familiar.

According to a first embodiment, the present invention provides a system for secure and rapid delivery of items. Through the use of this system a customer will be able to order and to obtain delivery of an item within a defined period at a location defined by the customer. Further, through the security features of the system, both the customer and the operator of the system will have confidence that the correct purchase will be delivered to the correct recipient.

The system may operate in e-commerce channels. For example, the system may host or cause to be hosted on a server, an e-commerce storefront on an e-commerce website. Accordingly, through the use of a web-browser a customer may access an interactive website designed and controlled by the system. Access to the web-browser may, for example, be accomplished through the use of smart phones and computers. A “smart phone” is a mobile phone that offers one or more if not all of the following advanced capabilities: e-mail, internet access, music, video, GPS and location applications, mapping applications and game applications. Input devices may also contain one or more of a real or virtual keyboard, a mouse and a graphic viewing interface.

Through the e-commerce channel, the system presents a description of the inventory that is available for purchase and delivery. The presentation may be in the form of text, graphics or a combination of text and graphics. The system stores this information in a database that identifies a plurality of items that are available for sale and the location of the item where the item is physically located prior to being purchased.

The database may contain the inventory of a plurality of vendors. Preferably the database is updated frequently, e.g., regular or irregularly at a frequency of every fifteen minutes to every two hours, every one hour to every three hours, every two hours to every four hours, every four hours to every six hours, every six hours to every twelve hours, or every twelve hours to every twenty-four hours. The updating of the information in the database may occur by, for example, each vendor sending an update with a regular frequency within one of the aforementioned ranges or by sending an update as new items are purchased or returned or as new inventory is delivered from a supplier. Alternatively or additionally, the system may send queries to the vendors when the system wants an update. If the system and the vendors' computers are appropriately configured and compatible, the updates can occur without human intervention. The system should be used to input or to collect data only from vendors who consent to participate with the system, and the system is to be used in applications that respect all ownership interests of vendors in their data.

The database may also index information such that within the database the availability of each item and each store at which it is located is noted. As customers are aware, the same items can be located at a plurality of locations that are either part of the same chain or are franchises of each other, e.g., the GAP®, Banana Republic®, Barnes & Noble®, and Starbucks® or at competitors' stores, e.g., Duane Reade® and CVS®. (Reference to particular stores or franchises herein are used for the purpose of illustration and does not denote a willingness of those vendors to participate in the systems of the present invention.) For example, if ten GAP stores have the item in stock in a particular size, the database will contain data that denotes this. Descriptions of items may in whole or in part be denoted by their SKU numbers.

In some embodiments, the system may be designed such that a customer may need to login to the website through the use of a user identity and a pass code. A customer may also have a profile that is stored by the system and that defines a customer's default geographic location, e.g., New York City, London, Madrid, or Tokyo. Additionally or alternatively, a customer may select a specific location to which she wishes the delivery to be made, for example, a street address, which will define the geographic area of vendors from whom purchases can be made as being those within the same metropolitan area or as within a distance that enables delivery with the denoted timeframe. Further, in some embodiments when a customer accesses the site, the system uses GPS technology such as that implemented by SKYHOOK® to determine the location at the time of logging into the system, and subsequently tracks the customer at any point in time and directs the delivery of the item to its precise location, and the vendors whose items may be purchased are those in the same metropolitan area. As persons skilled in the art are aware, there are known triangulation protocols that enable one to determine the location of cellular telephones when they are in use. The system may make use of these protocols to determine the location of the device that is being used to access the site and to place the order, and subsequently to direct the precise delivery of the item.

After logging into the system, the customer may visit a plurality of web pages and add various items that she wishes to purchase to her shopping cart. The act of shopping through e-commerce channels and the use of e-shopping carts on these sites are well-known to both customers and operators of these sites.

The system can be designed to present shopping options to a customer in any one of a number of ways. For example, a customer may be presented access to all data in the database. However, items that are not at any vendors who are located within a distance to permit delivery with the desired timeframe may be grayed out (or otherwise appear with a marking or attribute that suggests unavailability to be purchased and delivered within the timeframe and/or unavailable for selection). Alternatively or additionally, a pop-up window might appear asking if a customer is willing to take delivery at a later time if the item is available for sale, but not delivery within the designated timeframe.

If the customer answers in the affirmative, the purchase may continue. In other embodiments, the customer may be presented only with information for products that are within a defined geographic area or are capable of being retrieved and delivered within a desired timeframe, e.g., less than five hours, less than four hours, less than three hours, less than two hours, less than one and one-half hours, less than one hour, or less than thirty minutes. The system may either set the time window or give the customer the option of a time window. For example, there may be a default window of ninety minutes, but after reviewing the website, the customer may not see what she wants, and may extend the timeframe and thereby extend the geographic range of vendors in order to see more inventory.

Alternatively or additionally, there may be no default timeframe, and a user may need to enter the time at the start of a shopping experience. Still further, there may be a rendezvous option in which a customer designates a precise time and place for delivery, which may, for example, be a location, a point of interest, an anticipated delivery location or kiosk operated by the system or affiliated with the system. In these cases the system may present options for shopping that are capable of permitting delivery at the desired time and place.

In some embodiments when presented with the shopping experience, the street location of the item and/or the vendor's name may be withheld from the customer. For example, a customer may shop for GAP® sweaters through the system but not be presented with the information as to which GAP® store has the sweater in the size and color that she chose. By way of another example, a customer may seek to purchase Tylenol® but not be presented with the identity of the vendor from whom it will be retrieved. The customer may, in some embodiments, also be precluded from comparison shopping for the same item.

The geographic area may, for example, be defined by a distance from the location of the cellular telephone at the time of placing an order, or the delivery destination, or the anticipated delivery location, which may be a street address or a point of interest. For example, a customer who seeks delivery in Central Park, New York, may have a defined geographic area that is in the island of Manhattan or the five boroughs of New York City depending on the time window. Alternatively, the geographic area may be defined as within a radius of less than fifty miles, less than forty miles, less than thirty miles, less than twenty miles, less than ten miles, less than five miles, less than four miles, less than three miles, less than two miles, less than one mile or less than one-half miles. Still further, in other embodiments, the geographic area may be determined based on zip codes or postal codes. Thus, if a customer orders from within a zip code, that customer may gain access only to information within that zip code or within that zip code and the closest two, three, four, five, six, seven, eight, nine, or ten, etc. other zip codes. In the simplest embodiments, they system considers the average time to transverse a distance either by car, bus, train or on foot and the time within which an order is desired to be made. It then multiplies these two numbers to obtain a distance from the delivery destination within which a store may be located for purchases to be permitted. The system may then limit access by the customer to data for items in stores that are located within distance.

Furthermore, because in some locales, physical distance is not the only determinant of travel time, the customer's access to information in a database may be limited based on the estimated time that it would take to deliver an item that has been ordered that takes this variable into consideration. For example, a delivery destination that is on one side of a bridge may be close to a store on the other side of the bridge, but because the bridge crossing may be known to take a significant amount of time, the system may not provide the customer with the option of seeing items that are only located in that store, or the system may factor in the amount of time necessary to cross the bridge in determining whether the store is holding the item with the shortest estimated delivery time.

After a customer completes her order, she may pay for the order through any of the known methods for making payments through e-commerce channels. For example, PayPal®. The system then accesses its inventory locator algorithm, which may be located on the same server as the e-commerce website or on a remote server. The inventory locator algorithm will, after receiving a first piece of data comprising the customer's identity, a second piece of data comprising a delivery destination, and a third piece of data comprising an ordered item that has been selected by the customer, search the database for a location of the ordered item that has the shortest estimated delivery time to the delivery destination. Thus, whereas initially the database may be accessed to present any items that are capable of being delivered within a selected timeframe, after the order is placed, the system determines which stores have the item and from which store it can be retrieved for the fastest delivery.

After determining the location of the ordered item that has the shortest estimated delivery time, the system contacts the vendor who currently has the item in stock and directs the item to be pulled. The information may be sent by, for example, text or metadata or a combination thereof. At this time the system may request verification that the vendor has the item in stock. The item may be pulled by an employee of the vendor or an in store agent of the operator of the system who either is dispatched to the vendor or is already present at the vendor. If the agent is already present at the vendor (e.g., as may be cost-effective when the vendor is a large department store), the agent may, for example, have an actual desk or a virtual desk at the vendor that enables her to be there until an order is placed. A “virtual desk” refers to a communication device such as a smart phone that enables the agent to communicate with the system by, for example, e-mail, SMS technologies or other wired or wireless technologies.

Either to the vendor or the in store agent, the system sends an order identification code. The order identification code may comprise information that corresponds to the first piece of data, the second piece of data and the third piece of data. The order identification code is sent to the location of the ordered item that has the shortest estimated delivery time to the delivery destination. The system may also send a receipt to the customer that confirms that the order has been received and/or has been confirmed as being in stock at a vendor that enables delivery within a selected window. In some embodiments, the vendor or the in store agent associates the order identification code with the item that was purchased.

For example, the order identification code may be a bar code, a code based on letters, a code based on numbers or an alphanumeric code or a combination thereof. The code may be printed on a label and after the item is put into packaging for transit, the label may be affixed to the package. In some embodiments, the order identification code may be capable of being scanned after being printed (or after being affixed to the package) and transmitted back to the system. Alternatively, if the code is numeric, alphabetic or alphanumeric it may be scanned or input into a device and transmitted back to the system. In some embodiments, the tracking parameters makes use of NFC (near field communication) technology.

For example, the agent may scan the order identification code into his communication device and transmit the scanned file back to the system or otherwise input the code into his communication device. The receipt of this communication from the agent may be interpreted by the system as the start of delivery from the vendor to the delivery destination. It also may be that after this scan is received, the system causes the vendor to be paid. The vendor may be paid less than the system collects from the customer. The difference between what the vendor gets paid and what the system collects, is the system's fee for acting as the customer's agent. This fee may be determined based on a per item delivery or a flat fee or a monthly fee or a percentage of the cost of the item or a combination of these methods.

The system may also contain a verification algorithm, wherein said verification algorithm causes the system to transmit a customer identification code to the customer, and causes the system to issue a confirmation of correct delivery of the ordered item, if the system receives both the order identification code and the customer identification code from an agent. The agent may provide these codes directly or indirectly, through instrumentally such as his communication device or the customer's device or a third party's device. The agent may be the aforementioned in store agent, or a delivery person who retrieves the package from the in-store agent.

The system may also be designed to enable the customer to view the progress of the delivery of the item through a text and/or visually based computer mobile application.

The term “item” includes any type of goods that may be purchase, sold and delivered, such as retail items. Non-limiting examples of items include apparel, electronics, books, DVDs, CDs, movies and pharmaceuticals.

The systems, methods and computer program products of the present invention may be implemented through technologies that are now known or that come to be known that may be appreciated by persons of ordinary skill in the art as being of use in connection with the present invention.

The system may be implemented through one or more computers or central processing units. The phrase “central processing unit” and the abbreviation “CPU” are used interchangeably and refer to an electronic circuit that can execute a computer program and can accomplish electronic communication through for example a processor. A processor is the part of a computer that can execute instructions and manipulate data. An example of a processor is a central processing unit. The phrase “computer program product” as used herein, refers to instructions that can be stored on hardware, software or a combination of both.

The system may have specific software, including a browser that standardizes communication with network servers. These servers may be any devices that are capable of receiving, delivering and sending email messages, text messages and/or other messages that are sent to it. Thus, a server may comprise a storage device, an input device, an output device, a memory device, a processor and a communication interface.

The customers, vendors, delivery personnel and agents, may communicate with the system through one or more input devices, output devices, and communication interfaces. An input device is any device that may be used to input, to select and or to manipulate information. By way of example, input devices include, but are not limited to, a keyboard, a mouse, a graphic tablet, a joystick, a light pen, a microphone, and a scanner.

An output device may be any device that enables a computer to present information to a user, and includes, but is not limited to, a video display, a printer, and an audio speaker.

A communication interface is a tool for receiving input and sending input. Thus, it is or is part of a portal or is operably coupled to a portal. By way of example, communication interfaces may include but are not limited to a modem, network interface card and requisite software such as for protocol conversion and data conversion to communicate through e.g., a LAN, WAN or otherwise over the Internet. A “portal” is a method, system or apparatus for connecting to a network. For example, a portal may be a means of accessing the Internet.

The database that is accessed by the system may be stored on a memory device. A memory device is a device that can store, retrieve or facilitate the retrieval of data. By way of example, a memory device may comprises one or more of Random Access Memory (RAM), Read Only Memory (ROM), a magnetic drive, a Digital Video Disk (DVD) drive, or removable media storage.

According to another embodiment, the present invention provides a method for ensuring rapid and secure delivery of one or more items. In some embodiments, this method is partially or completely automated by one or more computers and communication devices. In this method, an order for an item is received from a customer. The order contains, or has associated with it, the customer's identity, a delivery destination for the item, and an identification of the item.

The customer may place the order through a portal on a website, via a text message, through email or over the telephone. The customer's location at the time of placing the order may also be determined or approximated through direct input by the customer or GPS technologies located in a mobile device.

In some embodiments, the delivery destination is a destination other than the customer's home or office. Further, the delivery destination may be an address or it may be a location of a person holding the input device while the order was placed or the actual location later inhabited by the customer as tracked by the system during the time that the item is being delivered. Because the person holding the device may move around in space, when the delivery destination is defined as the place where the device is located at the time of delivery this type of delivery destination may be referred to as a mobile delivery destination. For example, if the delivery destination is a mobile destination, the order may be placed while the customer is standing in Grand Central Station (a first location), but her delivery destination may be denoted as a mobile delivery destination between 48^{th} street and 59^{th} street on Madison Avenue in New York City (a second location that is mobile).

The customer gains access to an e-commerce website, wherein the customer is restricted to placing orders only for items that are located at a place that allows for their delivery within a selected time. In some embodiments, the customer will only be presented with items that can be delivered within the selected time.

After the order is received, a database is searched for the location of the item that permits its delivery to the delivery destination in the shortest estimated time or at a specified time or within a specified window that is selected by the customer. The shortest estimated delivery time is the prediction of time that will permit the fastest delivery of the item from a vendor to the delivery destination given one or more of distance and traffic patterns.

After receiving the order, the item is retrieved from a vendor. Until the order has been received, the item remains in the vendor's inventory and at the vendor's store or storage site. Further, the vendor has not sold the item until after it has been ordered.

Either before or after the item is retrieved, an order identification code is associated with the item. The order identification code uniquely identifies the item, the customer and delivery destination. The person who associates the order identification code with the item may be an employee of the vendor or an outside agent. This order identification code may be input into a system after association with the item. In some embodiments, the item is placed in tamperproof, weatherproof and/or wrinkle resistant packaging before association.

In some embodiments, after the item is ordered and the vendor from whom it will be retrieved is notified, the vendor may place the item in a holding location. If there is no in-store agent or if the in store agent is not the same as the delivery person, a delivery mechanism is selected, preferably automatically, and a delivery person goes to the vendor to retrieve the item. The delivery person may scan the code into an optical reader or otherwise input the code into a communication device that either directly or indirectly, through interfacing with a central processing unit, informs or confirms the delivery destination to the customer. Through GPS technologies, the delivery person's movements may be tracked and displayed on an active map.

Next a confirmation code is sent to a customer. This may, for example, be sent via email, SMS, text messaging, graphic image file, telephone or otherwise.

Finally, the item is delivered to the customer at the delivery destination and there is verification that the correct customer has received the confirmation code. Delivery may be accomplished by a person who acts as an agent of the customer. A customer may designate a proxy for receipt such as a doorman, but in order for the package to be turned over, the doorman would need the confirmation code.

In the method, one may also track delivery of the item. Based on either the order identification code and/or the time of pick up from the vendor, one may send to the customer an estimated time of arrival as for example, a text, e-mail message or graphic image file. The person who delivers the package may be equipped with one or more devices that enable his movement, as well as that of the package to be tracked. Accordingly, the estimated time of delivery may be modified to reflect the delivery person's progress.

In another embodiment, the present invention provides a computer program product stored in a tangible medium. The medium may be a non-transitory tangible computer readable storage medium comprising a set of executable instructions that are capable of directing a computer to execute the necessary steps for the modules below to perform their intended purpose.

A “non-transitory tangible computer readable storage medium” may also be referred to as a computer program product, and includes hardware, software or a combination of the two on which one may store a set of instructions that may be used to direct a computer to perform a set of steps. Examples of non-transitory tangible computer readable storage medium include, but are not limited to, a hard drive, a hard disk, a floppy disk, a thumb drive, a computer tape, ROM, EEPROM, nonvolatile RAM, CD-ROM and a punch card. Thus, in some embodiments the instructions are software stored on a medium that can instruct a computer having one or more of the following hardware components: memory, storage, an input device, an output device and a central processing unit.

The term “module” refers to a computer program product that may be stored on hardware and/or software that may be activated by a user to carry out a defined set of steps and/or to prompt a user to provide information through, for example, a graphic user interface and/or input/output device. Thus, a module may be stored in the form of a tangible medium.

A first module of the computer program product is an e-commerce module. Through the e-commerce module a customer may access information about an item that may be purchased and delivered to the customer within a set timeframe and the customer may both purchase an item and designate a delivery destination. In some embodiments, the e-commerce module limits the customer's access to information about an item for potential purchase based on the customer's location at the time of placing the order or estimated location at the time of delivery. In other embodiments, the e-commerce module limits the customer's access to information about an item for potential purchase based on a defined metropolitan area. Through this module, the customer may place one or more orders for goods.

A second module of the computer program product is an order fulfillment module. The order fulfillment module is operably coupled to the e-commerce module and the order fulfillment module executes a set of instructions that determines the location of the item that permits the shortest time of delivery to the delivery destination after an order has been placed. The phrase “operably coupled” refers to any connection that allows interoperability, including for example, being communicably coupled.

A third module of the computer program product is a tracking module. The tracking module transmits an order identification code to be associated with the item. The tracking module may also be configured to send the customer an estimated time of delivery in for example, the form of a text or e-mail message or graphic image file. A message to the customer may be sent at one or more times, for example, at the time that the order identification has been confirmed as being associated with this item and/or an interval during delivery, and/or a set number of minutes prior to delivery.

A fourth module of the computer program product is an authentication module. The authentication module sends an identity confirmation code to the customer, and if the authentication module receives the identity confirmation code and the order identification code from an agent, then the authentication module transmits a confirmation of correct delivery to the agent and/or customer. The authentication module may send the identity confirmation code at a first time and transmit a confirmation of correct delivery only if the authentication module receives the identity confirmation code and the order identification code from the agent within a predetermined number of minutes after the authentication module sends the identity confirmation code. By way of example, the first time (the of sending the identity confirmation code) may be forty-five minutes or less, thirty minutes or less, fifteen minutes or less, ten minutes or less, five minutes or less, three minutes or less, two minutes or less or one minute or less before an estimated time of delivery. The agent may be instructed not to deliver the item to the customer if the agent does not receive the confirmation of correct delivery.

The computer program product may further comprise a customer location module. The customer location module determines the customer's location at a specific time through the use of GPS technology. The delivery person may make use of this module when trying to locate the person within an area, for example a park or point of interest.

In some embodiments, the authentication module sends the confirmation of correct delivery only if the authentication module receives the identity confirmation code and the order identification code from the agent within a set time of having sent the identity confirmation code. By way of example the time may be with thirty minutes or less after the estimated time of arrival, fifteen minutes or less after the estimated time of arrival, ten minutes or less after the estimated time of arrival, five minutes or less after the estimated time of arrival, four minutes or less after the estimated time of arrival, three minutes or less after the estimated time of arrival, two minutes or less after the estimated time of arrival or one minute or less after the estimated time of arrival. The expiration of the identity confirmation code may alternatively be measured from the time of sending the identity confirmation code, e.g., within forty-five minutes, within thirty minutes, within twenty-five minutes, within twenty minutes, within fifteen minutes, within ten minutes or within five minutes.

The system, methods and computer program products may also enable delivery of a plurality of goods to the same customer. If the goods are located at different vendors, the customer may be presented with an option of a plurality of deliveries or within an estimated time that takes into account pick-ups from multiple vendors.

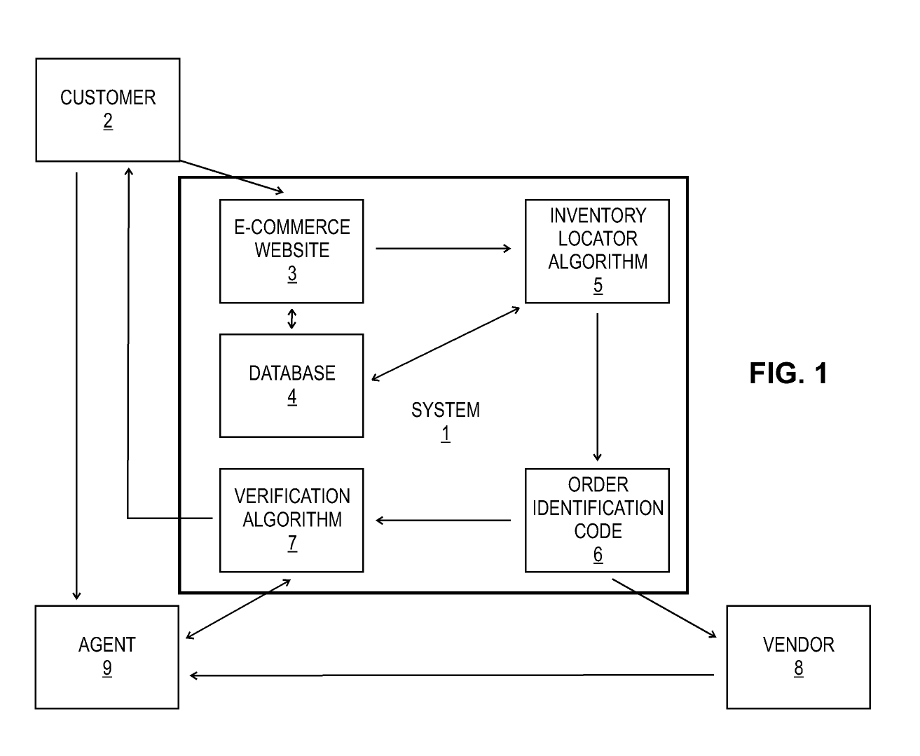

The present invention may further be understood by reference to FIG. 1. In FIG. 1, a representation of a system 1 is shown. A customer 2 accesses an e-commerce website 3. Through the website, she accesses and retrieves information from a database 4 that contains information about items that are available for purchase. After an order is placed on the website, the system causes the inventory locator algorithm 5 to be accessed.

The inventory location algorithm accesses the database 4 and retrieves information in order to determine, based on the order placed by the customer and the delivery destination contained within that order, which vendor that has the ordered item in stock would provide for the shortest delivery time to the delivery destination. The system then causes an order identification code 6 to be generated. This code is sent to a vendor 8. The code may be sent as part of an email, an attachment to an email, through a text message, such as an SMS message, or by other means.

The vendor then causes the order identification code to be associated with the item that was purchased, and transfers this item to an agent of the system 7.

The system also causes the verification algorithm 7 to receive the order identification code and to send an identity confirmation code to the customer 2. The verification algorithm waits for the agent to transmit both the order identification code, which it retrieved from the vendor and the identity confirmation code, which it received from the customer. If the agent sends both of the codes, the system sends a confirmation of correct delivery to the agent, which instructs the agent to turn the item over to the customer.

The advantages of the various embodiments of the present invention can easily be recognized. For example, a customer who finds himself inappropriately dressed for an event can readily order apparel such as a sweater, raincoat or dinner jacket. A parent who is at an amusement park whose child has gone through all of her diapers can readily order and obtain more diapers without leaving the park. An individual who left his medications at home can obtain a necessary dose, provided that all legal requirements for sale and delivery have been met.

Unless otherwise specified, any of the features of the various embodiments described herein can be used in conjunction with features described in connection with any other embodiments disclosed. Accordingly, features described in connection with the various or specific embodiments are not to be construed as not suitable in connection with other embodiments disclosed herein unless such exclusivity is explicitly stated or implicit from the context.

1. A system for secure and rapid delivery of an item comprising:
(a) a database comprising data that identifies an item that is available for sale and the location of the item;
(b) an e-commerce website, wherein the e-commerce website is accessible to a customer and the customer may navigate the website in order to gain access to information in said database;
(c) an inventory locator algorithm, wherein said inventory locator algorithm, after receiving a first piece of data comprising the customer's identity, a second piece of data comprising a delivery destination, and a third piece of data comprising an ordered item that has been selected by said customer, searches said database for a location of the ordered item that has the shortest estimated delivery time to the delivery destination;
(d) an order identification code comprising information that corresponds to the first piece of data, the second piece of data and the third piece of data, wherein the order identification code is sent to the location of the ordered item that has the shortest estimated delivery time to the delivery destination; and
(e) a verification algorithm, wherein said verification algorithm causes the system to transmit a customer identification code to said customer, and causes the system to issue a confirmation of correct delivery of the ordered item, if the system receives both the order identification code and the customer identification code from an agent.

2. The system of claim 1, wherein the item comprises at least one of apparel, electronics, books, DVDs, CDs, movies and pharmaceuticals.

3. The system of claim 1, wherein within said e-commerce website, said customer's access to information in said database is restricted to information about an item that is located within a geographic distance from the delivery destination that renders the item capable of being delivered within a timeframe.

4. The system of claim 3, wherein the timeframe is three hours or less.

5. The system of claim 4, wherein the timeframe is ninety minutes or less.

6. The system of claim 4, wherein the geographic distance is five miles or less.

7. The system of claim 1, wherein the shortest estimated delivery time is determined by finding the shortest physical distance between the location of the item and the delivery destination.

8. The system of claim 1, wherein within the database, an item is identified as being located at a plurality of locations.

9. A method for ensuring rapid and secure delivery of an item, said method comprising:
(a) receiving an order for an item from a customer, wherein the order contains the customer's identity, a delivery destination for the item, and an identification of the item;
(b) searching a database for the location of the item that permits its delivery to the delivery destination in the shortest estimated time;
(c) retrieving the item from a vendor, after receiving the order;
(d) associating an order identification code with the item;
(e) sending a confirmation code to a customer; and
(f) delivering the item to the customer at the delivery destination and verifying that the customer has received the confirmation code.

10. The method according to claim 9, wherein the shortest estimated time is determined by the location of the item that has been ordered that is the closest in distance to the delivery destination.

11. The method according to claim 9, wherein the delivery destination is a destination other than the customer's home or office.

12. The method according to claim 9 further comprising determining the customer's location at the time of placing the order.

13. The method according to claim 12 further comprising tracking delivery of the item.

14. The method according to claim 13 further comprising sending to said customer an estimated time of arrival.

15. The method according to claim 9 further comprising allowing said customer access to an e-commerce website, wherein the customer is restricted to placing orders only for items that are located at a place that allows for their delivery within a selected time.

16. The method according to claim 15, wherein on the e-commerce website, the customer will be presented only with items that can be delivered within the selected time.

17. The method according to claim 9, wherein in step (c) an agent retrieves the item from the vendor and in step (f) the agent delivers the item to the customer.

18. The method according to claim 17, wherein the vendor associates the order identification code with the item, and the agent inputs the order identification code into a device.

19. A computer program product stored in a tangible medium that comprises:
(a) an e-commerce module, wherein through said e-commerce module a customer may access information about an item that may be purchased and delivered to the customer within a set timeframe and the customer may both purchase an item and designate a delivery destination;
(b) an order fulfillment module, wherein said order fulfillment module is operably coupled to the e-commerce module and the order fulfillment module executes a set of instructions that determines the location of the item that determines the shortest estimated time of delivery to the delivery destination;
(c) a tracking module, wherein said tracking module transmits an order identification code to be associated with said item; and
(d) an authentication module, wherein the authentication module sends an identity confirmation code to the customer, and if the authentication module receives the identity confirmation code and the order identification code from an agent, then the authentication module transmits a confirmation of correct delivery.

20. The computer program product of claim 19, wherein the tracking module sends the customer an estimated time of delivery.

21. The computer program product of claim 20 further comprising a customer location module, wherein the customer location module determines the customer's location at a specific time through the use of GPS technology.

22. The computer program product of claim 21, wherein the e-commerce module limits the customer's access to information about items for potential purchase based on the customer's location at the time of placing the order.

23. The computer program product of claim 21, wherein the e-commerce module limits the customer's access to information about items for potential purchase based on a defined metropolitan area.

24. The computer program product of claim 19, wherein the authentication module sends the identity confirmation code at a first time and transmits with confirmation of correct delivery only if the authentication module receives the identity confirmation code and the order identification code from the agent within a predetermined number of minutes after the authentication module sends the identity confirmation code.

25. The computer program product of claim 24, wherein the first time is fifteen minutes or less before an estimated time of arrival.

26. The computer program product of claim 25, wherein the authentication module sends the confirmation of correct delivery only if the authentication module receives the identity confirmation code and the order identification code from the agent within thirty minutes of having sent the identity confirmation code.
